(19) United States
(12) Patent Application Publication
(10) Pub. No.: US 2025/0224645 A1
(43) Pub. Date: Jul. 10, 2025

(54) ELECTROPHORETIC MEDIUM COMPRISING PARTICLES HAVING A PIGMENT CORE AND A POLYMERIC SHELL

(71) Applicant: E Ink Corporation, Billerica, MA (US)

(72) Inventors: Sherry Hsin-Yi TSAI, Chelmsford, MA (US); Ziyan WU, Wayland, MA (US); Stephen J. TELFER, Arlington, MA (US); Xiaolong ZHENG, Fremont, CA (US); Marcus David COLE, Dublin, CA (US); Hong-Loan Tran NGUYEN, Menlo Park, CA (US); Suhasini KISHORE, Newark, CA (US); Jiancheng LUO, Sunnyvale, CA (US)

(21) Appl. No.: 19/007,768

(22) Filed: Jan. 2, 2025

Related U.S. Application Data
(60) Provisional application No. 63/617,957, filed on Jan. 5, 2024.

(51) Int. Cl. G02F 1/167; G02F 1/1675; G02F 1/16757

(52) U.S. Cl. CPC G02F 1/167; G02F 1/16757; G02F 2001/1678; G02F 2202/022

(57) ABSTRACT

An electrophoretic medium is disclosed, the electrophoretic medium comprising a plurality of a first type of particles, a plurality of a second type of particles, and a non-polar liquid. Each of the plurality of the first type of particles has a core and a shell. The core comprises a pigment. The shell of the first type of particles comprises a polymer, the polymer being a homopolymer or a copolymer. The homopolymer is formed by a vinylnaphthalene and the copolymer is formed by a vinylnaphthalene and a first monomer.

### RELATED APPLICATIONS

This application claims priority to U.S. Provisional Patent Application No. 63/617,957 filed on Jan. 5, 2024, which is incorporated by reference in its entirety, along with all other patents and patent applications disclosed herein.

### FIELD OF THE INVENTION

This invention relates to particles that comprise a core and a shell, the core comprising a pigment, and the shell comprising a polymer, the polymer being formed by a vinylnaphthalene. The particles can be used in electrophoretic media of electro-optic devices.

### BACKGROUND OF THE INVENTION

The term “electro-optic”, as applied to a material, a device, or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT), E Ink Corporation, E Ink California, LLC. and related companies describe various technologies used in encapsulated and microcell electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. The technologies described in these patents and applications include:

(a) Electrophoretic particles, fluids and fluid additives; see for example U.S. Pat. Nos. 5,961,804; 6,017,584; 6,120,588; 6,120,839; 6,262,706; 6,262,833; 6,300,932; 6,323,989; 6,377,387; 6,515,649; 6,538,801; 6,580,545; 6,652,075; 6,693,620; 6,721,083; 6,727,881; 6,822,782; 6,831,771; 6,870,661; 6,927,892; 6,956,690; 6,958,849; 7,002,728; 7,038,655; 7,052,766; 7,110,162; 7,113,323; 7,141,688; 7,142,351; 7,170,670; 7,226,550; 7,230,750; 7,230,751; 7,236,290; 7,277,218; 7,286,279; 7,312,916; 7,382,514; 7,390,901; 7,473,782; 7,561,324; 7,583,251; 7,572,394; 7,576,904; 7,580,180; 7,679,814; 7,848,006; 7,903,319; 8,018,640; 8,115,729; 8,257,614; 8,270,064; 8,363,306; 8,390,918; 8,582,196; 8,654,436; 8,902,491; 8,961,831; 9,052,564; 9,341,915; 9,348,193; 9,361,836; 9,366,935; 9,372,380; 9,382,427; 9,423,666; 9,428,649; 9,557,623; 9,670,367; 9,671,667; 9,688,859; 9,726,957; 9,752,034; 9,765,015; 9,778,535; 9,778,537; 9,835,926; 9,953,588; 9,995,987; 10,025,157; 10,031,394; 10,040,954; 10,061,123; 10,062,337; 10,147,366; and 10,514,583; and U.S. Patent Application Publication Nos. 2003/0048522; 2003/0151029; 2003/0164480; 2004/0030125; 2004/0105036; 2005/0012980; 2009/0009852; 2011/0217639; 2012/0049125; 2013/0161565; 2013/0193385; 2013/0244149; 2013/0063333; 2014/0011913; 2014/0078576; 2014/0104674; 2014/0231728; 2015/0177590; 2015/0185509; 2015/0241754; 2015/0301425; and 2016/0170106.

(b) Capsules, binders and encapsulation processes; see for example U.S. Pat. Nos. 5,930,026; 6,067,185; 6,130,774; 6,262,706; 6,327,072; 6,392,786; 6,459,418; 6,727,881, 6,839,158; 6,866,760; 6,922,276; 6,958,848; 6,987,603; 7,110,164; 7,148,128; 7,184,197; 7,304,634; 7,327,511, 7,339,715; 7,411,719; 7,477,444; 7,561,324; 7,910,175; 7,952,790; 8,129,655; 8,446,664; and U.S. Patent Applications Publication Nos. 2005/0156340; 2007/0091417; and 2009/0122389.

(c) Microcell structures, wall materials, and methods of forming microcells; see for example U.S. Pat. Nos. 6,672,921; 6,751,007; 6,753,067; 6,781,745; 6,788,452; 6,795,229; 6,806,995; 6,829,078; 6,850,355; 6,865,012; 6,870,662; 6,885,495; 6,930,818; 6,933,098; 6,947,202; 7,046,228; 7,072,095; 7,079,303; 7,141,279; 7,156,945; 7,205,355; 7,233,429; 7,261,920; 7,271,947; 7,304,780; 7,307,778; 7,327,346; 7,347,957; 7,470,386; 7,504,050; 7,580,180; 7,715,087; 7,767,126; 7,880,958; 8,002,948; 8,154,790; 8,169,690; 8,441,432; 8,891,156; 9,279,906; 9,291,872; 9,388,307; 9,436,057; 9,436,058; 9,470,917; 9,919,553; and 10,401,668; and U.S. Patent Applications Publication Nos. 2003/0203101; 2014/0050814; and 2016/0059442.

(d) Methods for filling and sealing microcells; see for example U.S. Pat. Nos. 6,545,797; 6,788,449; 6,831,770; 6,833,943; 6,930,818; 7,046,228; 7,052,571; 7,166,182; 7,347,957; 7,374,634; 7,385,751; 7,408,696; 7,557,981; 7,560,004; 7,564,614; 7,572,491; 7,616,374; 7,715,087; 7,715,088; 8,361,356; 8,625,188; 8,830,561; 9,346,987; and 9,759,978; and U.S. Patent Applications Publication Nos. 2002/0188053; 2004/0120024; 2004/0219306; and 2015/0098124.

(c) Films and sub-assemblies containing electro-optic materials; see for example U.S. Pat. Nos. 6,825,829; 6,982,178; 7,110,164; 7,158,282; 7,554,712; 7,561,324; 7,649,666; 7,728,811; 7,826,129; 7,839,564; 7,843,621; 7,843,624; 7,952,790; 8,034,209; 8,177,942; 8,390,301; 9,238,340; 9,470,950; 9,835,925; and U.S. Patent Applications Publication Nos. 2005/0122563; 2007/0237962; and 2011/0164301.

(f) Backplanes, adhesive layers and other auxiliary layers and methods used in displays; see for example U.S. Pat. Nos. D485,294; 5,930,026; 6,120,588; 6,124,851; 6,177,921; 6,232,950; 6,252,564; 6,312,304; 6,312,971; 6,376,828; 6,392,786; 6,413,790; 6,480,182; 6,498,114; 6,506,438; 6,518,949; 6,545,291; 6,639,578; 6,657,772; 6,664,944; 6,683,333; 6,710,540; 6,724,519; 6,816,147; 6,819,471; 6,825,068; 6,831,769; 6,842,279; 6,842,657; 6,865,010; 6,873,452; 6,909,532; 6,967,640; 7,012,600; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,301,693; 7,304,780; 7,327,346; 7,327,511; 7,347,957; 7,365,733; 7,388,572; 7,401,758; 7,492,497; 7,535,624; 7,551,346; 7,554,712; 7,560,004; 7,583,427; 7,649,674; 7,667,886; 7,672,040; 7,688,497; 7,826,129; 7,830,592; 7,839,564; 7,880,958; 7,893,435; 7,905,977; 7,952,790; 7,986,450; 8,034,209; 8,049,947; 8,072,675; 8,120,836; 8,159,636; 8,177,942; 8,237,892; 8,362,488; 8,395,836; 8,437,069; 8,441,414; 8,456,589; 8,514,168; 8,547,628; 8,576,162; 8,610,988; 8,714,780; 8,743,077; 8,754,859; 8,797,258; 8,797,633; 8,797,636; 9,147,364; 9,025,234; 9,025,238; 9,030,374; 9,140,952; 9,201,279; 9,223,164; 9,238,340; 9,285,648; 9,454,057; 9,529,240; 9,620,066; 9,632,373; 9,666,142; 9,671,635; 9,715,155; 9,777,201; 9,897,891; 10,037,735; 10,190,743; 10,324,577; 10,365,533; 10,372,008; 10,446,585; 10,466,565; 10,495,941; 10,503,041; 10,509,294; 10,613,407; and U.S. Patent Applications Publication Nos. 2002/0060321; 2004/0085619; 2004/0105036; 2005/0122306; 2005/0122563; 2006/0255322; 2009/0122389; 2010/0177396; 2011/0164301; 2011/0292319; 2014/0192000; 2014/0210701; 2014/0368753; and 2016/0077375; and International Application Publication Nos. WO2000/038000; WO2000/005704; and WO1999/067678.

(g) Color formation and color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909.

(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777.

(i) Applications of displays; see for example U.S. Pat. Nos. 6,118,426; 6,473,072; 6,704,133; 6,710,540; 6,738,050; 6,825,829; 7,030,854; 7,119,759; 7,312,784; 7,705,824; 8,009,348; 8,011,592; 8,064,962; 8,162,212; 8,553,012; 8,973,837; 9,188,829; and 9,197,704; and U.S. Patent Applications Publication Nos. 2002/0090980; 2004/0119681; 2007/0285385; 2013/0176288; 2013/0221112; 2013/0233930; 2013/0235536; 2014/0049808; 2014/0062391; 2014/0206292; and 2016/0035291; and International Application Publication No. WO 00/36560.

(j) Non-electrophoretic displays, as described in U.S. Pat. Nos. 6,241,921; 6,784,953; 6,795,138; 6,914,713; 6,950,220; 7,095,477; 7,182,830; 7,245,414; 7,420,549; 7,471,369; 7,576,904; 7,580,180; 7,850,867; 8,018,643; 8,023,071; 8,282,762; 8,319,759; and 8,994,705 and U.S. Patent Applications Publication Nos. 2005/0099575; 2006/0262249; 2007/0042135; 2007/0153360; 2008/0020007; 2012/0293858; and 2015/0277160; and applications of encapsulation and microcell technology other than displays; see for example U.S. Pat. No. 7,615,325; and U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

The quality of the image of an electrophoretic device comprising electrophoretic medium having charged pigment particles in a non-polar liquid may be reduced because charge particles of the electrophoretic medium aggregate, especially in the case of organic pigments. This particle aggregation may take place between charge particles of the same type or between charge pigment particles of different types. For example, an electrophoretic medium may contain charged particles having four different colors, such as blue, red, yellow, and white. In such electrophoretic media, aggregation between blue-red and blue-yellow particles prevent complete separation between electrophoretic particle during the device operation, leading to less chromatic color states of the device. A similar electrophoretic medium may contain charged particles comprising pigments of cyan, magenta, yellow, and white, and aggregation between cyan-magenta, cyan-yellow, and magenta-yellow may take place with detrimental effects in the electro-optic performance of the device. The aggregation between organic pigment particles may be somewhat mitigated if one or more of the organic pigments, such as for example, the cyan or the blue pigment, is replaced by an inorganic pigment having similar color property. However, in general, inorganic pigments do not provide colors with high chroma in comparison to organic pigments. Thus, there is a need to improve the particles that are used in electrophoretic media. In addition, the initially formed image of an electro-optic device may change over time. For example, a white state of a device may shift to a white state that is slightly color-tinted, reducing the overall image quality. Thus, there is a need to design electrophoretic particles in electrophoretic media that contribute to more stable optical states. The inventors of the present invention surprisingly found that using particles that comprise (1) a core comprising a pigment particle, and (2) a shell comprising a polymer formed by a monomer, wherein the monomer is a vinylnaphthalene, significantly improve the electro-optic performance of the corresponding device by providing more chromatic color states and also more stable optical states over time.

One of the problems that is occasionally observed under certain conditions in electrophoretic displays is “image sticking”. It is caused when a type of electrophoretic particles are strongly adsorbed on a surface of a microcell of the electro-optic material layer and said type of electrophoretic particles are not completely removed upon application of an electric field, preventing an effective switching of the microcell from a first color state to a second color state. In such cases, the second color state is contaminated with the first color state, reducing the image quality of the electro-optic display. The problem was mitigated in the past by having electrophoretic media that included filler particles in addition to electrophoretic charged particles (see U.S. Pat. No. 8,115,729B2). However, the inclusion of filler particles also increases the viscosity of the electrophoretic medium, increasing the switching speed between color states and also increasing the required voltage for the switch between optical states. The inventors of the present invention surprisingly found that image sticking can be mitigated without affecting the viscosity of the electrophoretic medium by surface treating of the corresponding electrophoretic particles with a polymer that is formed by a vinylnaphthalene monomer and polydimethylsiloxane macromer, the polymer having a weight average molecular weight that is larger than 55,000 Daltons.

### SUMMARY OF THE INVENTION

According to one aspect of the present invention, an electrophoretic medium comprises a non-polar liquid, a plurality of a first type of particles, and a plurality of second type of particles. Each of the plurality of the first type of particles comprises a core and a shell. The core comprises a pigment having a surface; the pigment is an organic or inorganic pigment. The shell comprises a polymer, the polymer being a homopolymer or a copolymer. The homopolymer is formed by a vinylnaphthalene. The copolymer is formed by a vinylnaphthalene and a first monomer. The homopolymer or copolymer are in contact with the surface of the pigment. The polymer of the shell may have weight average molecular weight of from 55,000 to 500,000 Da, from 55,000 to 400,000 Da, from 55,000 to 300,000 Da, from 55,000 to 350,000 Da, from 55,000 to 300,000, from 55,000 to 250,000, or from 55,000 to 200,000 Da. The polymer of the shell may have weight average molecular weight that is larger than 55,000.

The vinylnaphthalene may be 1-vinylnaphthalene, 2-vinylnaphthalene, a substituted 1-vinylnaphthalene, and a substituted 2-vinylnaphthalene, wherein the substituted 1-vinylnaphthalene and the substituted 2-vinylnaphthalene have one or more substituents on an aromatic carbon of a naphthalene ring in addition to the vinyl substituent. The one or more substituent may be selected from the group consisting of halogen, alkoxy group, alkyl group, nitro, carboxyl group, hydroxy group, sulfonic group, sulfonate group, and amino group.

The first monomer may be a macromer. The macromer may have a molecular structure that includes a first functional group and a second functional group. The first functional group may be polydimethylsiloxane and the second functional group maybe a vinyl group, a methacrylate group, or an acrylate group.

The first monomer may have a molecular structure, the molecular structure of the first monomer including a functional group selected from the group consisting of a vinyl group, an acrylate group, and a methacrylate group. The first monomer may be selected from the group consisting of methyl methacrylate, methyl acrylate, ethyl methacrylate, ethyl acrylate, ethylhexyl methacrylate, ethylhexyl acrylate, lauryl methacrylate, lauryl acrylate, 2,2,2-trifluoroethyl methacrylate, 2,2,2-trifluoroethyl acrylate, styrene, and alpha-methylstyrene.

The copolymer may be formed by the vinylnaphthalene, the first monomer, and a second monomer, wherein the first monomer is 2,2,2-trifluoroethyl methacrylate and the second monomer has a molecular structure that includes (i) a polydimethylsiloxane and (ii) a vinyl functional group, an acrylate functional group, or a methacrylate functional group, wherein the copolymer may have weight average molecular weight of from 55,000 to 250,000 Da, from 55,000 to 200,000 Da, or from 55,000 to 180,000 Da. The copolymer may be formed by a vinylnaphthalene, the first monomer, and a second monomer, wherein the first monomer is 2,2,2-trifluoroethyl methacrylate and the second monomer is monomethacryloxypropyl terminated polydimethylsiloxane, wherein the copolymer may have weight average molecular weight of from 55,000 to 250,000 Da, from 55,000 to 200,000 Da, or from 55,000 to 180,000 Da. The copolymer may be formed by a vinylnaphthalene, a first monomer, a second monomer, and a third monomer.

The electrophoretic medium may also comprise a plurality of a third type of particles and a plurality of fourth type of particles. The first and second types of particles may comprise an organic pigment, the third type of particles may comprise an organic pigment, and the fourth type of particles may comprise an inorganic pigment. The first, second, and third type of particles may have a first charge polarity and the fourth type of particles may have a second charge polarity; the first charge polarity may be opposite to the second charge polarity.

The first, second, and third types of particles may be independently selected from the group selected from cyan, magenta, yellow, blue, green, and red, and wherein the color of the fourth type of particles is white.

The first, second and third types of particles may be independently selected from the group consisting of an azo pigment, a phthalocyanine pigment, a quinacridone pigment, a perylene pigment, a diketopyrrolopyrrole pigment, a benzimidazolone pigment, an isoindoline pigment, an anthranone pigment, an indanthrone pigment, a rhodamine pigment, a benzinamine pigment, a carbon black pigments, and mixtures therein.

The first, second and third types of particles may be independently selected from the group consisting of Pigment Blue 15, 15:1, 15:2, 15:3, 15:4 15:6, 60, and 79; Pigment Red 2, 4, 5, 9, 12, 14, 38, 48:2, 48:3, 48:4, 52:2, 53:1, 57:1, 81, 112, 122, 144, 146, 147, 149, 168, 170, 176, 177, 179, 184, 185, 187, 188, 208, 209, 210, 214, 242, 254, 255, 257, 262, 264, 282, and 285; C.I. Pigment Violet 1, 19, 23, and 32; C.I. Pigment Yellow 1, 3, 12, 13, 14, 15, 16, 17, 73, 74, 81, 83, 97, 109, 110, 111, 120, 126, 127, 137, 138, 139, 150, 151, 154, 155, 174, 175, 176, 180, 181, 184, 191, 194, 213 and 214; C.I. Pigment Green 7, and 36; C.I. Pigment Black 1, and 7; C.I. Pigment Brown 25, 32, 41; Pigment Orange 5, 13, 34, 36, 38, 43, 61, 62, 64, 68, 67, 72, 73, and 74, and mixtures thereof.

The electrophoretic medium may comprise a first, second, third, fourth, and fifth type of particles. The fifth type of particles may comprise an inorganic pigment or an organic pigment. The first and fourth types of particles may have charge polarity that is opposite to the charge polarity of the second, third, and fifth type of particles. The first and fourth type of particles may be negatively charged, wherein the second, third, and fifth type of particles may be positively charged. If the first and fourth type of particles are negatively charged, the first type of particles may have zeta potential that is more negative than the zeta potential of the fourth type of particles. If the second, third, and fifth types of particles are positively charged, the fifth type of particles may have zeta potential that is larger than the zeta potential of the second and third type of particles. The color of the fourth and fifth type of particles may be selected from the group selected from white and black.

According to another aspect of the present invention, an electro-optic device comprises a first light-transmissive electrode layer, an electro-optic material layer comprising the electrophoretic medium, and a second electrode layer. The electrophoretic medium comprises a non-polar liquid, a plurality of a first type of particles, and a plurality of second type of particles. Each of the plurality of the first type of particles comprising a core and a shell. The core comprises a pigment having a surface, and the shell comprises a polymer, the polymer being a homopolymer or a copolymer. The homopolymer is formed by a vinylnaphthalene. The homopolymer is formed by a vinylnaphthalene. The copolymer is formed by a vinylnaphthalene and a first monomer. The homopolymer or copolymer are in contact with the surface of the pigment. The vinylnaphthalene may be 1-vinylnaphthalene, 2-vinylnaphthalene, a substituted 1-vinylnaphthalene, and a substituted 2-vinylnaphthalene, wherein the substituted 1-vinylnaphthalene and the substituted 2-vinylnaphthalene have one or more substituents on an aromatic carbon of a naphthalene ring in addition to the vinyl substituent. The one or more substituent may be selected from the group consisting of halogen, alkoxy group, alkyl group, nitro, carboxyl group, hydroxy group, sulfonic group, sulfonate group, and amino group.

According to yet another aspect of the present invention, a method of manufacture of an electrophoretic medium, the electrophoretic medium comprising a non-polar liquid and a plurality of a first type of particles, the first type of particles having a core and a shell, the method of manufacture comprising the steps (a) providing a first dispersion comprising an organic pigment in a first organic solvent; (b) adding a vinylnaphthalene, a first monomer, and a free radical initiator into the first dispersion and mixing to form the first type of shell particles; (c) washing the first type of particles with a second organic solvent; and (d) dispersing the washed particles in a non-polar liquid. The first dispersion may further comprise a charge control agent. The method of manufacture may further comprise a step of adding a charge control agent into the dispersion of the washed particles in the non-polar liquid. The method of manufacture may further comprise a step of adding a second dispersion comprising an organic or an inorganic pigment in the non-polar liquid into dispersion of the washed particles in the non-polar liquid.

### BRIEF DESCRIPTION OF DRAWINGS

Various aspects and embodiments of the application will be described with reference to the following figures. It should be appreciated that the figures are not necessarily drawn to scale.

FIG. 1 is a side view of a portion of an electro-optic device comprising an electrophoretic medium encapsulated in a plurality of microcapsules. The device comprises a first light transmissive electrode layer, an electrophoretic material layer, a first adhesive layer, and a second electrode layer.

FIG. 2 is a side view of a portion of an electro-optic device comprising an electrophoretic medium encapsulated in a plurality of microcapsules. The device comprises a first light transmissive electrode layer, a second adhesive layer, an electrophoretic material layer, a first adhesive layer, and a second electrode layer.

FIG. 3 is a side view of a portion of an electro-optic device comprising an electrophoretic medium encapsulated in a plurality of microcells. The device comprises a first light transmissive electrode layer, a microcell layer, an adhesive layer, and a second electrode layer.

FIG. 4 shows a method for making microcells for the invention using a roll-to-roll process.

FIGS. 5A and 5B detail the production of microcells for an electro-optic device using photolithographic exposure through a photomask of a conductor film coated with a thermoset precursor.

FIGS. 5C and 5D detail an alternate embodiment in which microcells for an electro-optic device are fabricated using photolithography. In FIGS. 5C and 5D a combination of top and bottom exposure is used, allowing the partition walls in one lateral direction to be cured by top photomask exposure, and the partition walls in another lateral direction to be cured by bottom exposure through the opaque base conductor film.

FIGS. 6A-6D illustrate the steps of filling and sealing an array of microcells to be used in an electro-optic device.

### DETAILED DESCRIPTION OF THE INVENTION

“Dispersion polymerization” is a polymerization process that involves soluble starting materials (including monomers, initiators, etc.), where the polymer product precipitates out during the polymerization process. In the case of the process of manufacture of electrophoretic core-shell particles, the polymerization is performed in a pigment dispersion, enabling the precipitation of the polymer, which is formed by the dispersion polymerization, on the surface of the pigment particle.

The term “homopolymer” is a polymer that contains only one type of repeating units. Thus, a homopolymer is typically formed by one type of monomer.

The term “vinylnaphthalene” refers to a molecule that has a vinyl group, the vinyl group being bonded to an aromatic carbon atom of a naphthalene aromatic system. A naphthalene aromatic system is represented by Formula 1. The naphthalene aromatic system (Formula 1) comprises a condensed aromatic ring system having ten aromatic carbon atoms. The conventional numbering of the carbon atoms of a naphthalene is provided in Formula 1. A vinyl group is a molecular structure that is represented by Formula 2. A simpler, equivalent representation of a vinyl group is: —CH═CH₂.

The term “substituted 1-vinylnaphthalene” refers to a molecule that contains a naphthalene aromatic system, a vinyl group bonded to an aromatic carbon atom of the naphthalene aromatic system, and one or more substituents, the one or more substituents being bonded to an aromatic carbon atom of a naphthalene aromatic system. That is, the molecular structure of a substituted 1-vinylnaphthalene contains at least two substituents bonded to an aromatic carbon atom of the naphthalene aromatic system, one of the substituents being a vinyl group, the vinyl group being bonded to the carbon atom of position 1 of the naphthalene aromatic system (see Formula 1). In other words, a “substituted 1-vinylnaphthalene” has one or more substituents on an aromatic carbon atom of a naphthalene aromatic system in addition to the vinyl substituent. The one or more substituents cannot be hydrogen.

The term “substituted 2-vinylnaphthalene” refers to a molecule that contains a naphthalene aromatic system, a vinyl group bonded to an aromatic carbon atom of the naphthalene aromatic system, and one or more substituents, the one or more substituents being bonded to an aromatic carbon atom of a naphthalene aromatic system. That is, the molecular structure of a substituted 2-vinylnaphthalene contains at least two substituents bonded to an aromatic carbon atom of the naphthalene aromatic system, one of the substituents being a vinyl group, the vinyl group being bonded to the carbon atom of position 2 of the naphthalene aromatic system (see Formula 1). In other words, a “substituted 2-vinylnaphthalene” has one or more substituents on an aromatic carbon atom of a naphthalene aromatic system in addition to the vinyl substituent. The one or more substituents cannot be hydrogen.

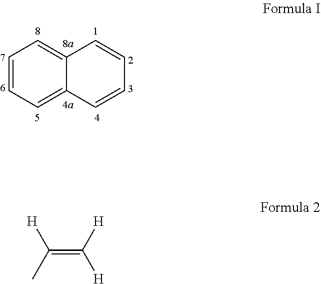

For the purpose of this invention, the numbering of the substituents of the vinylnaphthalene may not strictly follow the IUPAC rules. For the purpose of this invention, 1-vinylnaphthalene is any naphthalene that has a vinyl group covalently bonded to an aromatic carbon of the naphthalene aromatic system that is next to carbon 4a or next to carbon 8a of the naphthalene. For the purpose of this invention, 2-vinylnaphthalene is any naphthalene that has a vinyl group that is covalently bonded to an aromatic carbon of the naphthalene aromatic system that is not next to carbon 4a or next to carbon 8a of the naphthalene aromatic system. This means that, for the purpose of this invention, the numbering of the vinyl group takes priority to any other group that is covalently bonded to an aromatic carbon of the naphthalene aromatic system. That is, 2-chloro-6-naphthalene (shown in Formula 3) is still considered a 2-vinylnaphthalene, because the vinyl group in this compound is covalently bonded to an aromatic carbon of the naphthalene aromatic system that is not next to carbon 4a or next to carbon 8a of the naphthalene. The aromatic carbons of the naphthalene aromatic system are the carbons 1, 2, 3, 4, 4a, 5, 6, 7, 8, and 8a. In other words, compound “2-chloro-6-vinylnaphthalene” is considered to be a 2-vinylnaphthalene because it is equivalent to the less “officially acceptable” name “2-vinyl-6-chloronaphthalene”.

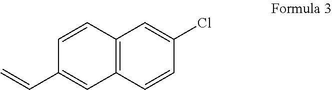

The term “macromer” (or “macromonomer”) is used to represent a relatively high molecular weight species (higher than 500 g/mol) having one functional group, the functional group being able to participate in a polymerization. In other words, a macromer can act as a monomer, although it has high molecular weight, or internal monomer units, in its molecular structure. Thus, a macromer can be considered a polymer. Typically, macromers contribute a single monomeric unit to a resulting polymer.

For this application, the term “copolymer” is a polymer that contains two or more different repeating units. A macromer is considered to comprise repeating units. A copolymer may be formed by two or more different types of monomers. For example, a terpolymer is considered to be a copolymer for the purpose of this invention. That is, copolymers may be formed by two, three, four, and so on, different types of monomers.

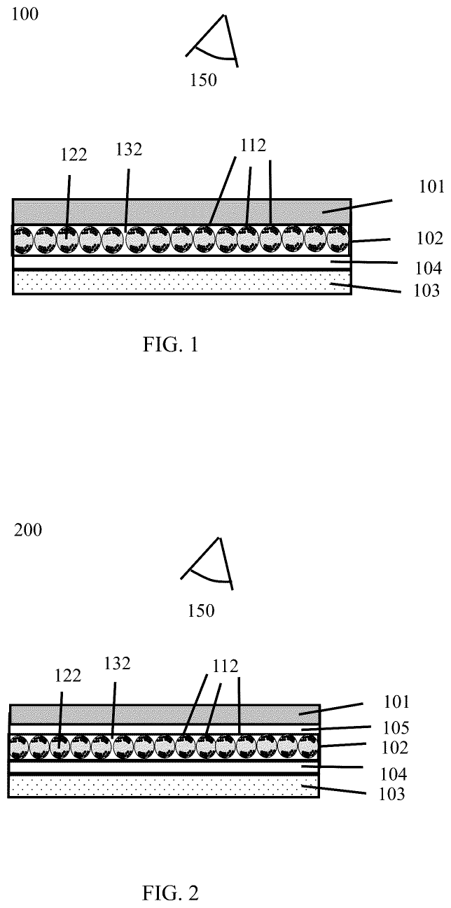

An example of an electro-optic device comprises an electro-optic material layer that includes an electrophoretic medium, which is encapsulated in microcapsules or microcells, as described in U.S. Pat. No. 6,982,178. FIG. 1 shows a side view of an example of the structure of a portion of an electro-optic device comprising microcapsules. Electro-optic device 100 comprises a first electrode layer 101 comprising a light transmissive electrode, an electro-optic material layer 102, a first adhesive layer 104, and a second electrode layer 103, the second electrode layer comprising a plurality of pixel electrodes. The first adhesive layer 104 connects the electro-optic material layer 102 with second electrode layer 103. The electro-optic material layer 102 comprises a plurality of microcapsules 112. Each microcapsule has a microcapsule wall and includes electrophoretic medium 122 having particles in a non-polar liquid. Typically, the plurality of microcapsules are retained within a polymeric binder 132. A viewer can view the image of device 100 from the viewing side 150. The electro-optic device 100 may be constructed from a front plane laminate, as described in the background of the invention.

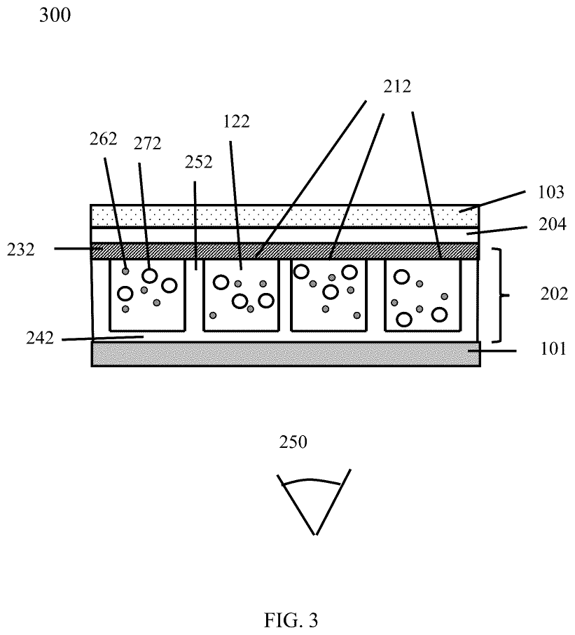

Another example of an electro-optic device is shown in FIG. 2. FIG. 2 illustrates a side view of an example of the basic structure of a portion of an electro-optic device having microcapsules. Electro-optic device 200 has a viewing side 150. It comprises, in order, a first electrode layer 101 comprising a light transmissive electrode, a second adhesive layer 105, an electro-optic material layer 102, a first adhesive layer 104, and a second electrode layer 103, comprising a plurality of pixel electrodes. The second adhesive layer 105 connects first electrode layer 101 with electro-optic material layer 102. The first adhesive layer 104 connects the electro-optic material layer 102 with the second electrode layer. The electro-optic material layer 102 comprises a plurality of microcapsules 112. Each microcapsule has a microcapsule wall and includes electrophoretic medium 122 having particles in a non-polar liquid. Typically, the plurality of microcapsules are retained within a polymeric binder 132. The electro-optic device 200 may be constructed from a double release sheet as described above.

The microcapsule electro-optic devices of FIGS. 1 and 2 may further comprise a light transmissive front substrate (not shown in FIGS. 1 and 2), which is adjacent to the first electrode layer 101, wherein the electrode layer is disposed between the front substrate and the electro-optic material layer (for the device of FIG. 1) or between the front substrate and the second adhesive layer (for the device of FIG. 1). The front substrate may be a plastic film, such as a sheet of poly(ethylene terephthalate) (PET) having thickness of from 25 to 200 μm. Front substrate may further comprise one or more additional layers, for example, a protective layer to absorb ultraviolet radiation, barrier layers to prevent ingress of oxygen or moisture into the device, and anti-reflection coatings to improve the optical properties of the device.

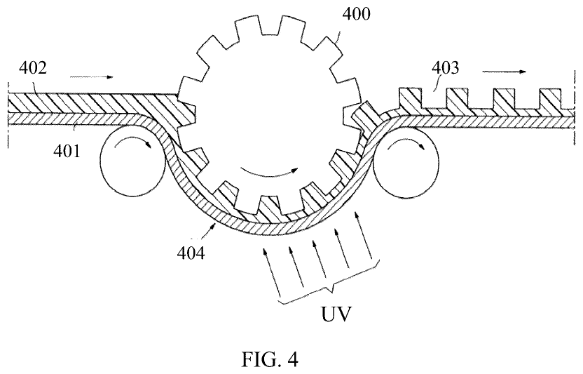

An example of an electro-optic device that comprises microcells is illustrated in FIG. 3. Electro-optic device 300 of FIG. 3 comprises, in order, a first electrode layer 101, an electro-optic material layer 202, an adhesive layer 204, and a second electrode layer 103, which comprises a plurality of pixel electrodes. Adhesive layer 204 connects sealing layer 232 of the electro-optic material layer 202 with second electrode layer 103 Electro-optic material layer 202 of electro-optic device 300 comprises a plurality of microcells 212 and a sealing layer 232. Each microcell 212 of the plurality of microcells has a bottom 242, partition walls 252, and an opening, the sealing layer 232 spanning the opening of each microcell. Each microcell 212 of the plurality of microcells comprises electrophoretic medium 122. Electrophoretic medium 122 comprises a plurality of first type of particles 272 and a plurality of second type of particles 262 in a non-polar liquid. A viewer can view the image of device 300 from the viewing side 250.

The microcell electro-optic device of FIG. 3 may further comprise a light transmissive front substrate (not shown in FIG. 3), which is adjacent to the first electrode layer 101, wherein the electrode layer is disposed between the front substrate and the electro-optic material layer. The light transmissive front substrate may be a plastic film, such as a sheet of poly(ethylene terephthalate) (PET) having thickness of from 25 to 200 μm. Light transmissive front substrate may further comprise one or more additional layers, for example, a protective layer to absorb ultraviolet radiation, barrier layers to prevent ingress of oxygen or moisture into the device, and anti-reflection coatings to improve the optical properties of the device.

In the electro-optic devices of FIGS. 1, 2, and 3, the first electrode layer may be a conductive layer having a thin continuous coating of electrically conductive material with minimal intrinsic absorption of electromagnetic radiation in the visible spectral range such as indium tin oxide (ITO), poly(3,4-ethylenedioxythiophene) poly(styrene sulfonate) (PEDOT:PSS), graphene or the like.

The electrophoretic medium 122 of electro-optic devices illustrated in FIGS. 1, 2, and 3 comprises a plurality of a first type of pigment particles and a plurality of a second type of pigment particles. Each of the plurality of the first type of particles comprises a core and a shell, the core comprising an organic pigment. Each of the plurality of the second type of particles may also comprise an organic pigment. Electrophoretic medium 122 may further comprise a plurality of third type of particles and a plurality of fourth type of particles. Electrophoretic medium 122 may further comprise a plurality of fifth type of particles. That is, electrophoretic medium 122 may comprise a plurality of first, second, third, and fourth types of particles. Electrophoretic medium 122 may comprise a plurality of first, second, third, fourth type, and fifth types of particles. The second type of particles may also comprise an organic pigment. The content of the electrophoretic particles in the non-polar liquid may vary. For example, one type of particles may take up 0.1% to 50%, preferably 0.5% to 15%, by volume of the non-polar liquid.

The electrophoretic medium of the present invention may comprise a charge control agent (CCA). The CCA controls the charge on the electrophoretic particles. The CCA is a surfactant-like molecule having an ionic or other polar group, hereinafter referred to as head groups, and a non-polar chain (typically a hydrocarbon chain) that is hereinafter referred to as the tail. The CCAs may be complexed with the charged particles or adsorbed onto the particles. It is thought that the CCA forms reverse micelles in the electrophoretic medium. It is a small population of charged reverse micelles that leads to electrical conductivity in the medium. Reverse micelles comprise a polar core that may vary in size from 1 nm to tens of nanometers, and may have spherical, cylindrical, or other geometry, surrounded by the non-polar tail groups of the CCA molecule. In electrophoretic media, three phases may typically be distinguished: a solid particle having a surface, a highly polar phase that is distributed in the form of extremely small droplets (reverse micelles), and a continuous phase that comprises the non-polar fluid. Both the electrophoretic particles and the charged reverse micelles may move through the fluid upon application of an electric field. Thus, there are two parallel pathways for electrical conduction through the fluid (which typically has a vanishingly small electrical conductivity itself). The content of the charge control agent in the electrophoretic medium may be from 0.1 weight percent to 8 weight percent, from 0.3 weight percent to 7 weight percent, from 0.5 weight percent to 5 weight percent, from 0.6 weight percent to 4 weight percent, from 0.7 weight percent to 3 weight percent, or from 0.8 weight percent to 2 weight percent of the charge control agent by weight of the electrophoretic medium.

The electrophoretic medium of the present invention comprises particles suspended in a non-polar liquid. The non-polar liquid may be clear and colorless. It preferably has a dielectric constant in the range of about 2 to about 30, preferably about 2 to about 15 for high particle mobility. Examples of suitable dielectric solvent include hydrocarbons such as isopar, decahydronaphthalene (DECALIN), 5-ethylidene-2-norbornene, fatty oils, paraffin oil, silicon fluids, aromatic hydrocarbons such as toluene, xylene, phenylxylylethane, dodecylbenzene or alkylnaphthalene, halogenated solvents such as perfluorodecalin, perfluorotoluene, perfluoroxylene, dichlorobenzotrifluoride, 3,4,5-trichlorobenzotri fluoride, chloropentafluoro-benzene, dichlorononane or pentachlorobenzene, and perfluorinated solvents such as FC-43, FC-70 or FC-5060 from 3M Company, St. Paul MN, low molecular weight halogen containing polymers such as poly(perfluoropropylene oxide) from TCI America, Portland, Oregon, poly(chlorotrifluoro-ethylene) such as Halocarbon Oils from Halocarbon Product Corp., River Edge, NJ, perfluoropolyalkylether such as Galden from Ausimont or Krytox Oils and Greases K-Fluid Series from DuPont, Delaware, polydimethylsiloxane based silicone oil from Dow-corning (DC-200).

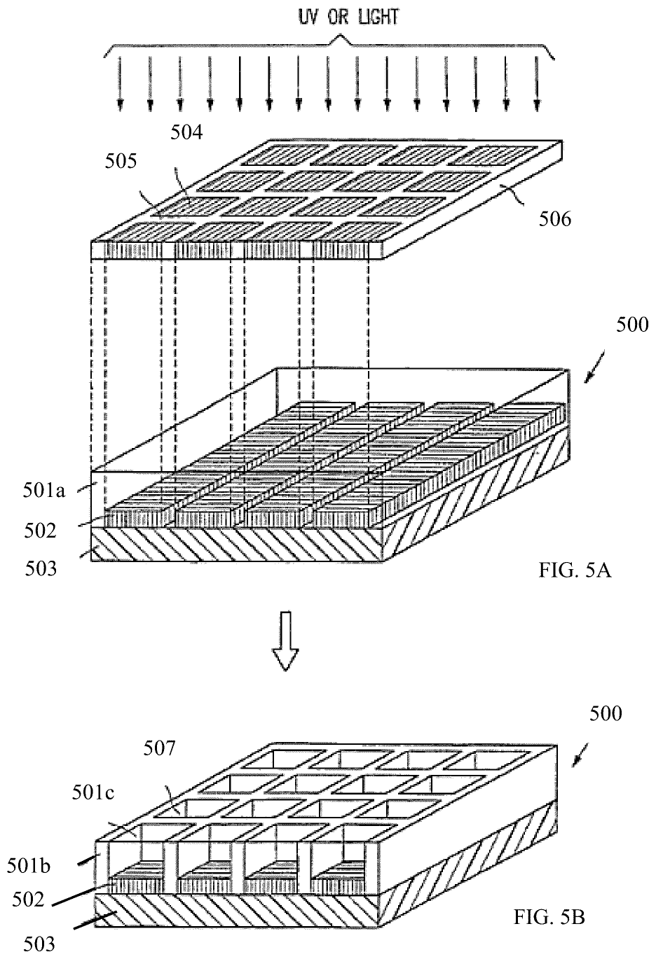

Microcells may be formed either in a batchwise process or in a continuous roll-to-roll process as disclosed in U.S. Pat. No. 6,933,098. The latter offers a continuous, low cost, high throughput manufacturing technology for production of compartments for use in a variety of applications including electro-optic devices. Microcell arrays suitable for use with the invention can be created with microembossing, as illustrated in FIG. 4. A male mold 402 may be placed either above the web 404, as shown in FIG. 4, or below the web 404 (not shown); however, alternative arrangements are possible. See U.S. Pat. No. 7,715,088, which is incorporated herein by reference in its entirety. A conductive substrate may be constructed by forming a conductor film 401 (first electrode) on polymer substrate that becomes the backing for a device. A composition comprising a thermoplastic, thermoset, or a precursor thereof 400 is then coated on the conductor film. The thermoplastic or thermoset precursor layer is embossed at a temperature higher than the glass transition temperature of the thermoplastics or thermoset precursor layer by the male mold in the form of a roller, plate or belt.

The thermoplastic or thermoset precursor for the preparation of the microcells may be multifunctional acrylate or methacrylate, vinyl ether, epoxide and oligomers or polymers thereof, and the like. A combination of multifunctional epoxide and multifunctional acrylate is also very useful to achieve desirable physico-mechanical properties. A crosslinkable oligomer imparting flexibility, such as urethane acrylate or polyester acrylate, may be added to improve the flexure resistance of the embossed microcells. The composition may contain polymer, oligomer, monomer and additives or only oligomer, monomer and additives. The glass transition temperatures (or T_{g}) for this class of materials usually range from about −70° C. to about 150° C., preferably from about −20° C. to about 50° C. The microembossing process is typically carried out at a temperature higher than the T_{g}. A heated male mold or a heated housing substrate against which the mold presses may be used to control the microembossing temperature and pressure.

As shown in FIG. 4, the mold is released during or after the precursor layer is hardened to reveal an array of microcells 403. The hardening of the precursor layer may be accomplished by cooling, solvent evaporation, cross-linking by radiation, heat or moisture. If the curing of the thermoset precursor is accomplished by UV radiation, UV may radiate onto the transparent conductor film from the bottom or the top of the web. Alternatively, UV lamps may be placed inside the mold. In this case, the mold must be transparent to allow the UV light to radiate through the pre-patterned male mold on to the thermoset precursor layer. A male mold may be prepared by any appropriate method, such as a diamond turn process or a photoresist process followed by either etching or electroplating. A master template for the male mold may be manufactured by any appropriate method, such as electroplating. With electroplating, a glass base is sputtered with a thin layer (typically 3000 Å) of a seed metal such as chrome inconel. The mold is then coated with a layer of photoresist and exposed to UV. A mask is placed between the UV and the layer of photoresist. The exposed areas of the photoresist become hardened. The unexposed areas are then removed by washing them with an appropriate solvent. The remaining hardened photoresist is dried and sputtered again with a thin layer of seed metal. The master is then ready for electroforming. A typical material used for electroforming is nickel cobalt. Alternatively, the master can be made of nickel by electroforming or electroless nickel deposition. The floor of the mold is typically between about 50 to 400 microns. The master can also be made using other microengineering techniques including e-beam writing, dry etching, chemical etching, laser writing or laser interference as described in “Replication techniques for micro-optics”, SPIE Proc. Vol. 3099, pp. 76-82 (1997). Alternatively, the mold can be made by photomachining using plastics, ceramics or metals.

Prior to applying a UV curable resin composition, the mold may be treated with a mold release to aid in the demolding process. The UV curable resin may be degassed prior to dispensing and may optionally contain a solvent. The solvent, if present, readily evaporates. The UV curable resin is dispensed by any appropriate means such as, coating, dipping, pouring or the like, over the male mold. The dispenser may be moving or stationary. A conductor film is overlaid the UV curable resin. Pressure may be applied, if necessary, to ensure proper bonding between the resin and the plastic and to control the thickness of the floor of the microcells. The pressure may be applied using a laminating roller, vacuum molding, press device or any other like means. If the male mold is metallic and opaque, the plastic substrate is typically transparent to the actinic radiation used to cure the resin. Conversely, the male mold can be transparent, and the plastic substrate can be opaque to the actinic radiation. To obtain good transfer of the molded features onto the transfer sheet, the conductor film needs to have good adhesion to the UV curable resin that should have a good release property against the mold surface.

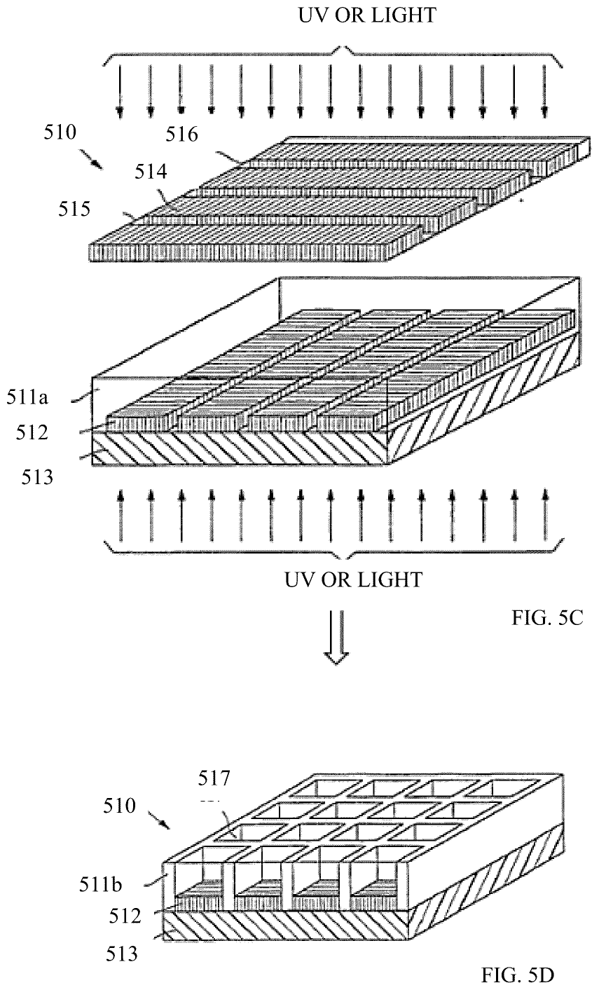

Photolithography. Microcells can also be produced using photolithography. Photolithographic processes for fabricating a microcell array are illustrated in FIGS. 5A and 5B. As shown in FIGS. 5A and 5B, the microcell array 500 may be prepared by exposure of a radiation curable material 501a coated by known methods onto a conductor film 502 to UV light (or alternatively other forms of radiation, electron beams and the like) through a mask 506 to form partition walls 501b corresponding to the image projected through the mask 506. The base conductor film 502 is preferably mounted on a supportive substrate base web 503, which may comprise a plastic material.

In the photomask 506 in FIG. 5A, the dark squares 504 represent the opaque area and the space between the dark squares represents the transparent area 505 of the mask 506. The UV radiates through the transparent area 505 onto the radiation curable material 502a. The exposure is preferably performed directly onto the radiation curable material 502a, i.e., the UV does not pass through the substrate 503 or base conductor 502 (top exposure). For this reason, neither the substrate 503, nor the conductor 502, needs to be transparent to the UV or other radiation wavelengths employed.

As shown in FIG. 5B, the exposed areas 501b become hardened and the unexposed areas (protected by the opaque area 504 of the mask 506) are then removed by an appropriate solvent or developer to form the microcells 507. The solvent or developer is selected from those commonly used for dissolving or reducing the viscosity of radiation curable materials such as methyl ethyl ketone (MEK), toluene, acetone, isopropanol, or the like. The preparation of the microcells may be similarly accomplished by placing a photomask underneath the conductor film/substrate support web and in this case the UV light radiates through the photomask from the bottom and the substrate needs to be transparent to radiation.

Imagewise Exposure. Still another alternative method for the preparation of the microcell array of the invention by imagewise exposure is illustrated in FIGS. 5C and 5D. When opaque conductor lines are used, the conductor lines can be used as the photomask for the exposure from the bottom. Durable microcell partition walls are formed by additional exposure from the top through a second photomask having opaque lines perpendicular to the conductor lines. FIG. 5C illustrates the use of both the top and bottom exposure principles to produce the microcell array 510 of the invention. The base conductor film 512 is opaque and line-patterned. The radiation curable material 511a, which is coated on the base conductor 512 and substrate 513, is exposed from the bottom through the conductor line pattern 512, which serves as the first photomask. A second exposure is performed from the “top” side through the second photomask 516 having a line pattern perpendicular to the conductor lines 512. The spaces 515 between the lines 514 are substantially transparent to the UV light. In this process, the partition wall material 511b is cured from the bottom up in one lateral orientation and cured from the top down in the perpendicular direction, joining to form an integral microcell 517. As shown in FIG. 5D, the unexposed area is then removed by a solvent or developer as described above to reveal the microcells 517.

The microcells may be constructed from thermoplastic elastomers, which have good compatibility with the microcells and do not interact with the electrophoretic media. Examples of useful thermoplastic elastomers include ABA, and (AB)n type of di-block, tri-block, and multi-block copolymers wherein A is styrene, α-methylstyrene, ethylene, propylene or norbornene; B is butadiene, isoprene, ethylene, propylene, butylene, dimethylsiloxane or propylene sulfide; and A and B cannot be the same in the formula. The number, n, is ≥1, preferably 1-10. Particularly useful are di-block or tri-block copolymers of styrene or ox-methylstyrene such as SB (poly(styrene-b-butadiene)), SBS (poly(styrene-b-butadiene-b-styrene)), SIS (poly(styrene-b-isoprene-b-styrene)), SEBS (poly(styrene-b-ethylene/butylenes-b-styrene)) poly(styrene-b-dimethylsiloxane-b-styrene), poly((α-methylstyrene-b-isoprene), poly(α-methylstyrene-b-isoprene-b-α-methylstyrene), poly(α-methylstyrene-b-propylene sulfide-b-α-methylstyrene), poly(α-methylstyrene-b-dimethylsiloxane-b-α-methylstyrene). Commercially available styrene block copolymers such as Kraton D and G series (from Kraton Polymer. Houston, Tex.) are particularly useful. Crystalline rubbers such as poly(ethylene-co-propylene-co-5-methylene-2-norbornene) or EPDM (ethylene-propylene-diene terpolymer) rubbers such as Vistalon 6505 (from Exxon Mobil, Houston, Tex.) and their grafted copolymers have also been found especially useful.

The thermoplastic elastomers may be dissolved in a solvent or solvent mixture that is immiscible with the display fluid in the microcells and exhibits a specific gravity less than that of the display fluid. Low surface tension solvents are preferred for the overcoating composition because of their better wetting properties over the microcell partition walls and the electrophoretic fluid. Solvents or solvent mixtures having a surface tension lower than 35 dyne/cm are preferred. A surface tension of lower than 30 dyne/cm is more preferred. Suitable solvents include alkanes (preferably C₆₋₁₂ alkanes such as heptane, octane or Isopar solvents from Exxon Chemical Company, nonane, decane and their isomers), cycloalkanes (preferably C₆₋₁₂ cycloalkanes such as cyclohexane and decalin and the like), alkylbenzenes (preferably mono- or di-C₁₋₆ alkyl benzenes such as toluene, xylene and the like), alkyl esters (preferably C₂₋₅ alkyl esters such as ethyl acetate, isobutyl acetate and the like) and C₃₋₅ alkyl alcohols (such as isopropanol and the like and their isomers). Mixtures of alkylbenzene and alkane are particularly useful.

In addition to polymer additives, the polymer mixtures may also include wetting agents (surfactants). Wetting agents (such as the FC surfactants from 3M Company, Zonyl fluorosurfactants from DuPont, fluoroacrylates, fluoromethacrylates, fluoro-substituted long chain alcohols, perfluoro-substituted long chain carboxylic acids and their derivatives, and Silwet silicone surfactants from OSi, Greenwich, Conn.) may also be included in the composition to improve the adhesion of the sealant to the microcells and provide a more flexible coating process. Other ingredients including crosslinking agents (e.g., bisazides such as 4,4′-diazidodiphenylmethane and 2,6-di-(4′-azidobenzal)-4-methylcyclohexanone), vulcanizers (e.g., 2-benzothiazolyl disulfide and tetramethylthiuram disulfide), multifunctional monomers or oligomers (e.g., hexanediol, diacrylates, trimethylolpropane, triacrylate, divinylbenzene, diallylphthalene), thermal initiators (e.g., dilauroryl peroxide, benzoyl peroxide) and photoinitiators (e.g., isopropyl thioxanthone (ITX), Irgacure 651 and Irgacure 369 from Ciba-Geigy) are also highly useful to enhance the physico-mechanical properties of the sealing layer by crosslinking or polymerization reactions during or after the overcoating process.

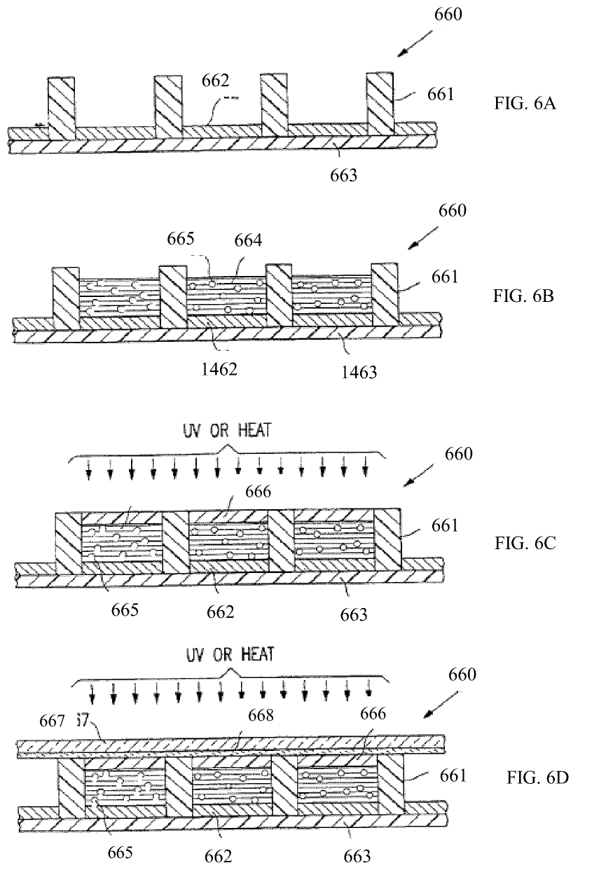

After the microcells are produced, they are filled with appropriate electrophoretic media. The microcell array 640 may be prepared by any of the methods described above. As shown in cross-section in FIGS. 6A-6D, the microcell partition walls 661 extend upward from the substrate 663 to form the open cells. The microcells may include a primer layer 662 to passivate the mixture and keep the microcell material from interacting with the mixture containing the electrophoretic medium 665.

The microcells are next filled with an electrophoretic medium 664 comprising particles 665 in a non-polar fluid. The microcells may be filled using a variety of techniques. In some examples, blade coating may be used to fill the microcells to the depth of the microcell partition walls 661. In other examples, inkjet-type microinjection can be used to fill the microcells. In yet other examples, microneedle arrays may be used to fill an array of microcells.

As shown in FIG. 6C, after filling, the microcells are sealed by applying a polymer 1466 that becomes the sealing layer. In some examples, the sealing process may involve exposure to heat, dry hot air, or UV radiation. Polymer 666 is compatible with the electrophoretic medium, but not dissolved by the fluid of the electrophoretic medium 664. Accordingly, the final microcell structure is mostly impervious to leaks and able to withstand flexing without delamination.

A variety of individual microcells may be filled with the desired electrophoretic medium by using iterative photolithography. The process typically includes coating an array of empty microcells with a layer of positively working photoresist, selectively opening a certain number of the microcells by imagewise exposing the positive photoresist, followed by developing the photoresist, filling the opened microcells with the desired mixture, and sealing the filled microcells by a sealing process.

After the microcells 660 are filled, the sealed array may be laminated with a finishing layer 668, preferably by pre-coating the finishing layer 668 with an adhesive layer that may be a pressure sensitive adhesive, a hot melt adhesive, or a beat, moisture, or radiation curable adhesive. The laminate adhesive may be post-cured by radiation such as UV through the top conductor film if the latter is transparent to the radiation.

The present invention provides an electrophoretic medium comprising a non-polar liquid, a plurality a first type of particles, and a plurality of a second type of particles. Each of the plurality of the first type of particles has a core and a shell. The core may comprise an organic pigment. The shell comprises a polymer, the polymer being in contact with the surface of the pigment of the core. The polymer of the shell may be a homopolymer or a copolymer. The homopolymer may be formed by a vinylnaphthalene. The copolymer may be formed by a vinylnaphthalene and a first monomer. The homopolymer or copolymer is in contact with the surface of the organic pigment of the core. The core-shell first type of particles may be formed via dispersion polymerization. In one example, the dispersion polymerization is a free radical polymerization of the monomer or monomers in the presence of pigment particles. If the core-shell particle is made via dispersion polymerization, the polymer of the shell is adsorbed on the pigment surface of the core.

The vinylnaphthalene may be 1-naphthalene, 2-naphthalene, a 1-naphthalene having one or more substituents on an aromatic carbon of the vinylnaphthalene, or a 2-naphthalene having one or more substituents in an aromatic carbon of the vinylnaphthalene.

The vinylnaphthalene may have a halogen substituent. Non-limited examples of halogen substituted 1-naphthalene and 2-naphthalene include 6-chloro-2-vinylnaphthalene, 6-bromo-2-vinylnaphthalene, 6-fluoro-2-vinylnaphthalene, 4-chloro-1-vinylnaphthalene, 4-bromo-1-vinylnaphthalene, 4-fluoro-1-vinylnaphthalene. 1-chloro-2-vinylnaphthalene, 1-bromo-2-vinylnaphthalene, and 1-fluoro-2-vinylnaphthalene.

The vinylnaphthalene may have an alkoxy substituent. The alkoxy substituent may be a methoxy or an ethoxy substituent. Non-limited examples of alkoxy substituted 1-naphthalene and 2-naphthalene include 6-methoxy-2-vinylnaphthalene, 7-methoxy-1-vinylnaphthalene, 4-methoxy-1-vinylnaphthalene, and 4-methoxy-2-vinylnaphthalene.

The vinylnaphthalene may have an alkyl substituent. The alkyl substituent may be a methyl, ethyl, propyl, butyl, pentyl, or other alkyl groups. Non-limited examples of alkyl substituted 1-naphthalene and 2-naphthalene include 1-methyl-2-vinylnaphthalene and 4-methyl-2-vinylnaphthalene.

Other non-limited examples of substituted 1-vinylnaphthalene and 2-vinylnaphthalene include 2-nitro-1-vinylnaphthalene, 6-carboxylic acid methyl ester-2-vinylnaphthalene, 6-hydroxy-2-vinylnaphthalene, 1-(2-fluorophenyl)-2-vinylnaphthalene, and 2,7-bis(ethenyl) naphthalene.

The shell of the first type of particles may comprise a copolymer. The copolymer may be formed by the reaction of a vinylnaphthalene and a first monomer. The first monomer may be a macromer.

Non-limiting examples of the first monomer include styrene, α-methyl styrene, methyl acrylate, methyl methacrylate, n-butyl acrylate, n-butyl methacrylate, t-butyl acrylate, t-butyl methacrylate, vinyl pyridine, n-vinyl pyrrolidone, 2-hydoxyethyl acrylate, 2-hydroxyethyl methacrylate, dimethylaminoethyl methacrylate, lauryl acrylate, lauryl methacrylate, 2-ethylhexyl acrylate, 2-ethylhexyl methacrylate, hexyl acrylate, hexyl methacrylate, n-octyl acrylate, n-octyl methacrylate, n-octadecyl acrylate, n-octadecyl methacrylate, 2-perfluorobutylethyl acrylate, 2,2,2 trifluoroethyl methacrylate, 2,2,3,3 tetrafluoropropyl methacrylate, 1,1,1,3,3,3-hexafluoroisopropyl acrylate, 1,1,1,3,3,3-hexafluoroisopropyl methacrylate, 2,2,3,3,3-pentafluoropropyl acrylate, 2,2,3,3-tetrafluoropropyl acrylate, 2,2,3,4,4,4-hexafluorobutyl methacrylate, and 2,2,3,3,4,4,4-heptafluorobutyl methacrylate or the like.

The macromer may contain a terminal functional group selected from the group consisting of an acrylate group, a methacrylate group, a vinyl group, or combinations thereof.

Examples of macromers that may be used to form the first type of particles are described in U.S. Patent Application No. 2018/0210312, the contents of which are incorporated herein by reference in its entirety. One type of macromer that may be used to form the polymer of the shell of the core-shell particle include acrylate terminated polysiloxane, such as Gelest, MCR-M11, MCR-M17, or MCR-M22, for example. The macromer may have a molecular structure that includes (i) polydimethylsiloxane and (ii) a vinyl functional group, a methacrylate group, or an acrylate group.

Another type of macromers which is suitable for the process is PE-PEO macromers, as shown below:

RₘO—[—CH₂CH₂O—]ₙ—CH₂-phenyl-CH═CH₂; or

RₘO—[—CH₂CH₂O—]ₙ—C(═O)—C(CH₃)═CH₂.

The substituent R may be a polyethylene chain, n is 1-60 and m is 1-500. The synthesis of these compounds may be found in Dongri Chao et al., Polymer Journal, Vol. 23, no. 9, 1045 (1991) and Koichi Ito et al, Macromolecules, 1991, 24, 2348. A further type of suitable macromers is PE macromers, as shown below:

CH₃—[—CH₂—]ₙ—CH₂O—C(═O)—C(CH₃)═CH₂.

The n, in this case, is 30-100. The synthesis of this type of macromers may be found in Seigou Kawaguchi et al, Designed Monomers and Polymers, 2000, 3, 263.

The first monomer may be selected from the group consisting of methyl methacrylate, lauryl methacrylate, 2,2,2-trifluoroethyl methacrylate, acrylate terminated polysiloxane, and methacrylate terminated polysiloxane.

The copolymer may be formed by a vinylnaphthalene, a first monomer, and a second monomer. The copolymer may be formed by a vinylnaphthalene, 2,2,2-trifluoroethyl methacrylate, and macromer having a structure that includes (i) a polydimethylsiloxane and (ii) a vinyl functional group, an acrylate functional group, or a methacrylate functional group. The macromer may be monomethacryloxypropyl terminated polydimethylsiloxane. The second monomers may be selected from the examples of monomers described above for the first monomer (including macromers).

The copolymer may be formed by a vinylnaphthalene, a first monomer, a second monomer, and a third monomer. The third monomers may be selected from the examples of monomers described above for the first monomer (including macromers).

The electrophoretic medium comprises a first type of particles and a second type of particles, the first type of particles having opposite charge polarity from the second type of particles.

The electrophoretic medium may comprise a first type of particles, a second type of particles, a third type of particles, and a fourth type of particles. The first, second, third, and fourth type of particles have different colors; the first, second, third, and fourth type of particles may comprise an organic pigment. The first, second, and third type of particles may have a charge polarity that is opposite of the charge polarity of the fourth type of particles. The fourth type of particles may comprise an inorganic pigment. The color of the first, second, and third type of pigments may be selected from the group consisting of blue, red, yellow, cyan, magenta, and green. The color of the fourth type of pigments may be white.

In one example, the first, second, and third type of particles may be selected from a group consisting of blue, red, and yellow, and the fourth types of particles may be white. In this example, the first type of particles may be yellow.

In another example, the first, second, and third type of particles may be selected from a group consisting of cyan, magenta, and yellow, and the fourth types of particles may be white. In this example, the first type of particles may be magenta.

The electrophoretic medium may comprise a first type of particles, a second type of particles, a third type of particles, and a fourth type of particles. The first, second, third, and fourth type of particles have different colors; the first, second, and third types of particles may comprise an organic pigment. The first and second type of particles may have a charge polarity that is opposite of the charge polarity of the third and fourth type of particles. The fourth type of particles may comprise an inorganic pigment. The color of the first, second, and third type of pigments may be selected from the group consisting of blue, red, yellow, cyan, magenta, and green. The color of the fourth type of pigments may be white.

The electrophoretic medium may comprise a first type of particles, a second type of particles, a third type of particles, a fourth type of particles, and a fifth type of particles. The first, second, third, fourth, and fifth type of particles have different colors; the first, second, and third types of particles may comprise an organic pigment. The first and second type of particles may have a charge polarity that is opposite of the charge polarity of the third and fourth type of particles. The fourth type of particles may comprise an inorganic pigment. The color of the first, second, and third type of pigments may be selected from the group consisting of cyan, magenta, and yellow. The color of the fourth type of pigments may be white. The first and fourth type of particles may be negatively charged, wherein the second, third, and fifth type of particles may be positively charged. The first type of particles may have zeta potential that is more negative than the zeta potential of the fourth type of particles. The fifth type of particles may have zeta potential that is larger than the zeta potential of the second and third type of particles. The color of the fourth and fifth type of particles may be selected from the group selected from white and black. In one example, the inventive electrophoretic medium has first, second, third, fourth, and fifth type of particles that have yellow, red, blue, white, and black colors respectively. In this example, the first and fourth type of particles are negatively charged and the zeta potential of the first type of particles is more negative than the zeta potential of the fourth type of particles. In the same example, the second, third and fifth type of particles are positively charged, and the fifth type of particles have zeta potential that is larger than the zeta potential of the second and third type of particles.

The organic pigment of the core of the first type of particles may be selected from the group consisting of an azo pigment, a phthalocyanine pigment, a quinacridone pigment, a perylene pigment, a diketopyrrolopyrrole pigment, a benzimidazolone pigment, an isoindoline pigment, an anthranone pigment, an indanthrone pigment, a carbon black pigment, a rhodamine pigment, a benzinamine pigment, a carbon black pigments, and mixtures therein.

The organic pigment of the first type of particles, the second type of particles, and the third type of particles may be independently selected from the group consisting of C.I. Pigment Blue 15, 15:1, 15:2, 15:3, 15:4 15:6, 60, and 79; Pigment Red 2, 4, 5, 9, 12, 14, 38, 48:2, 48:3, 48:4, 52:2, 53:1, 57:1, 81, 112, 122, 144, 146, 147, 149, 168, 170, 176, 177, 179, 184, 185, 187, 188, 208, 209, 210, 214, 242, 254, 255, 257, 262, 264, 282, and 285; C.I. Pigment Violet 1, 19, 23, and 32; C.I. Pigment Yellow 1, 3, 12, 13, 14, 15, 16, 17, 73, 74, 81, 83, 97, 109, 110, 111, 120, 126, 127, 137, 138, 139, 150, 151, 154, 155, 174, 175, 176, 180, 181, 184, 191, 194, 213 and 214; C.I. Pigment Green 7, and 36; C.I. Pigment Black 1, and 7; C.I. Pigment Brown 25, 32, 41; Pigment Orange 5, 13, 34, 36, 38, 43, 61, 62, 64, 68, 67, 72, 73, and 74, and mixtures thereof.

The electrophoretic medium of the present invention may be manufactured by a process comprising the steps of (a) providing a dispersion comprising an organic pigment in a first organic solvent; (b) adding a vinylnaphthalene, a first monomer, and a free radical initiator into the dispersion and mixing to form the first type of particles; (c) washing the first type of particles with a second organic solvent; (d) removing the first and second organic solvents; and (e) dispersing the washed particles transferring in a non-polar liquid. The process may further comprise a step of adding a charge control agent into the dispersion of the washed particles in the non-polar liquid.

The organic pigment of the core of the first type of particles of the present invention may have average diameter from 10 nm to about 100 μm, from 50 nm to 1 μm, or from 100 nm to 800 nm.

Organic pigments provide color because they absorb specific wavelengths of incident light that correspond to visible light. Typically, their color saturation and strength increases with decreasing particle size (that is, with increasing surface area). Thus, they are mostly available as relatively high surface area particles, which make them relatively difficult to disperse and stabilize in liquids.

The electrophoretic medium of the present invention may comprise a plurality of first, second, third, and fourth type of particles. The first type of particles comprise a core and a shell. The core comprises an organic pigment and the shell comprises a polymer. The second type of particles may also comprise a core and shell, with the core comprising an organic pigment, and the shell comprising a polymer. The third type of particles may also comprise a core and shell, with the core comprising an organic pigment, and the shell comprising a polymer. The fourth type of particles may also comprise a core and shell, with the core comprising an organic pigment, and the shell comprising a polymer. The fourth type of particles may comprise a core and shell, with the core comprising an inorganic pigment, and the shell comprising a polymer.

For the manufacture of the first type of particles, the quantities of the reagents used (e.g., the organic pigment, the vinylnaphthalene, the first monomer, the second monomer, if present, the third monomer, if present, and the initiator) may be adjusted to achieve the desired content of the core-shell particles. The process of manufacture may include more than one stage and/or more than one type of polymerization.

The first type of particles made according to the various embodiments of the present invention are dispersed in a non-polar liquid. It is desirable that the polymeric layer be compatible with the non-polar liquid. In practice, the suspending non-polar liquid in an electrophoretic medium is normally hydrocarbon-based, although the non-polar liquid can include a proportion of halocarbon, which is used to increase the density of the non-polar liquid and thus to decrease the difference between the density of the non-polar liquid and that of the particles. Accordingly, the polymer of the shell may include hydrocarbon chain to be compatible with the non-polar liquid of the electrophoretic medium, resulting in improve dispersion stability of the particle. In one example of the first type of particles, the polymer of the shell may have a branched or “comb” structure, with a main chain and a plurality of side chains extending away from the main chain. Each of these side chains may have four, five, six or more carbon atoms. The side chains may themselves be branched; for example, each side chain could be a branched alkyl group, such as a 2-ethylhexyl group.

There are two basic approaches to forming such a comb polymer. The first approach uses monomers, which inherently provide the necessary side chains. Typically, such a monomer has a single polymerizable group at one end of a long chain (at least four, and preferably at least six, carbon atoms). Monomers of this type, which have been found to give good results in the present processes, include hexyl acrylate, 2-ethylhexyl acrylate and lauryl methacrylate. Isobutyl methacrylate and 2,2,3,4,4,4-hexafluorobutyl acrylate have also been used successfully. In some cases, it may be desirable to limit the number of side chains formed in such processes, and this can be achieved by using a mixture of monomers (for example, a mixture of lauryl methacrylate and methyl methacrylate) to form a random copolymer in which only some of the repeating units bear long side chains. In the second approach, typified by an RGP-ATRP process, a first polymerization reaction is carried out using a mixture of monomers, at least one of these monomers bearing an initiating group, thus producing a first polymer containing such initiating groups. The product of this first polymerization reaction is then subjected to a second polymerization, typically under different conditions from the first polymerization, to cause the initiating groups within the polymer to cause polymerization of additional monomer on to the original polymer, thereby forming the desired side chains.

Free radical polymerization of ethylenic or similar radical polymerizable groups attached to particles may be effected at elevated reaction temperatures, preferably 60 to 70° C., using conventional free radical initiators, such as azobis(isobutyryinitrile) (AIBN), while ATRP polymerization can be effected using the conventional metal complexes, as described in Wang, J. S., et al., Macromolecules 1995, 23, 7901, and J. Am. Chem. Soc. 1995, 117, 5614, and in Beers, K. et al., Macromolecules 1999, 32, 5772-5776. See also U.S. Pat. Nos. 5,763,548; 5,789,487; 5,807,937; 5,945,491; 4,986,015; 6,069,205; 6,071,980; 6,111,022; 6,121,371; 6,124,411; 6,137,012; 6,153,705; 6,162,882; 6,191,225; and 6,197,883. The entire disclosures of these papers and patents are herein incorporated by reference. The presently preferred catalyst for carrying out ATRP is cuprous chloride in the presence of bipyridyl (Bpy).

It has been found that there is an optimum range for the amount of polymeric layer, which should be formed on electrophoretic particles, and that forming an excessive amount of polymer on the particles can degrade their electrophoretic characteristics. The optimum range will vary with a number of factors, including the density and size of the particles being coated, the nature of the suspending medium in which the particles are intended to be used, and the nature of polymer of the shell of the particles, and for any specific particle, polymer and non-polar liquid of the electrophoretic medium, the optimum range is best determined empirically. However, by way of general guidance, it should be noted that the denser the particle, the lower the optimum proportion of polymer by weight of the particle, and the more finely divided the particle, the higher the optimum proportion of polymer. In general, the polymer content of the particle may be higher than 2 weight percent, higher than 4 weight percent, or higher than 6 weight percent of polymer by weight of the particle.

The polymeric content of the particle may be from 1 to 50 weight percent, from 2 to 30 weight percent, from 4 to 20, from 5 to 15 weight percent, from 4 to 15 weight percent, from 6 to 15 weight percent, or from 8 to 12 weight percent by weight of the particle.

### EXAMPLES

### Example 1: Preparation of Inventive Yellow Particles

Into a 500 ml bottle, an amount of 60.0 g of Pigment Yellow 138 (Paliotol Yellow L 0962 HD supplied by BASF) were mixed with 88.8 g of monomethacryloxypropyl terminated polydimethylsiloxane (MCR-M22 supplied Gelest), and 480 mL of trimethylsiloxy terminated polydimethylsiloxane (DMS-T01 supplied by Gelest). The materials were mixed for 30 mins. The resulting mixture was transferred into a 1-liter reactor and an amount of 6.7 g of 2,2,2-trifluoroethyl methacrylate (supplied by Sigma) were added; the temperature was increased to 75° C. under stirring and under nitrogen atmosphere. When the temperature reached 75° C., a solution of 10.0 g of 2-vinylnaphthalene (supplied by Sigma) in 4 g ethyl acetate (supplied by Sigma) was added into the mixture. After 1 hour under nitrogen purging, a solution of 0.304 g of lauroyl peroxide initiator (supplied by Sigma) dissolved in 3.5 g of ethyl acetate (supplied by Sigma) was added into the reactor to initiate the polymerization. After 19 hours, the mixture was centrifuged at 5000 rpm for 20 minutes and the supernatant liquid was removed. The solids produced were redispersed in Isopar E, the dispersion was centrifuged, and the supernatant liquid was removed. This wash cycle was repeated twice, and the solids were dried at room temperature under vacuum to yield the particles. The polymer content of the final pigment was 11%; the zeta potential of the particles was-51 mV.

### Example 2: Preparation of Inventive Electro-Optic Device and Color Evaluation

An electrophoretic medium was prepared using a charged control agent, a hydrocarbon solvent, the negatively charged yellow particles form Example 1, positively charge blue particles, positively charged red particles, and negatively charged white particles. A microcell electro-optic device was prepared using the electrophoretic medium. The electro-optic device was driven to white state, dark state, red state, yellow state, blue state, and green state. The color of each state was measured using a color computer. Table 1 shows the result of the color measurement (in L*a*b*) of Example 2. W represents the white state, K represents the black state, R represents the red state, Y represents the yellow state, B represents the blue state, G represents the green state.

### Comparative Example 3: Preparation of Control Electro-Optic Device and Color Evaluation

The procedure of Example 2 was repeated, but, instead of the yellow particles from Example 1, control yellow particles were used for the comparative electrophoretic medium. Control yellow particles comprise a core and shell, the core comprising the same Pigment Yellow 138 as used in Example 1, and a shell that was formed by the polymerization of methyl methacrylate, monomethacryloxypropyl terminated polydimethylsiloxane, and 2,2,2-trifluoroethyl methacrylate. Table 2 shows the result of the color measurement (in L*a*b*) of Comparative Example 3. W represents the white state, K represents the black state, R represents the red state, Y represents the yellow state, B represents the blue state, G represents the green state.

TABLE 1
Color Measurement of Various Color States
of Electro-Optic Device of Example 2.

| | W | K | R | Y | B | G |
|---|---|---|---|---|---|---|
| L* | 66.8 | 13.9 | 26.5 | 63.9 | 33.9 | 48.7 |
| a* | −3.0 | 11.2 | 37.6 | −12.7 | 4.2 | −21.6 |
| b* | 1.2 | −8.3 | 24.0 | 64.5 | −38.8 | 36.4 |

TABLE 2
Color Measurement of Various Color States of Electro-
Optic Device of Comparative Example 3.

| | W | K | R | Y | B | G |
|---|---|---|---|---|---|---|
| L* | 66.6 | 12.8 | 27.4 | 65.4 | 42.5 | 53.9 |
| a* | −1.0 | 10.0 | 33.7 | −12.4 | −6.4 | −12.3 |
| b* | 0.6 | −3.6 | 23.3 | 37.8 | −19.3 | 9.1 |

Comparison of the data of Tables 1 and 2, shows that the inventive device has significantly improved yellow state (b* of 64.5 versus 37.8). Furthermore, the inventive device also shows improved red state (a* of 37.6 versus 33.7), blue state (b* −38.8 versus −9.3), and green state (a* of −38.8 versus −12.3).

### Examples 4A, 4B, 4C: Preparation of Series of Yellow Electrophoretic Particle Dispersions

A series of yellow electrophoretic particle dispersions (4A, 4B, 4C) were prepared using variations of the general synthesis process described in Example 1. For each dispersion, standard methodologies were utilized to adjust the weight average molecular weight of the copolymer that is present on the surface of the yellow pigment particles, the polymer being formed by the polymerization of 2-vinylnaphthalene, monomethacryloxypropyl terminated polydimethylsiloxane, and 2,2,2-trifluoroethyl methacrylate. The particles of each dispersion were separated from the medium and dried. The polymer content for yellow electrophoretic particles of each dispersion was determined by thermogravimetric analysis. In addition, the weight average molecular weight was determined by extracting the polymer from the dried particles by THF and analyzing the extract by gel permeation chromatography. Table 3 summarizes the polymer content (weight of polymer by weight of the electrophoretic particle) and weight average molecular weight of each yellow electrophoretic particle from the series.

### Example 5A, 5B, 5C: Preparation of Electro-Optic Device and Evaluation of Image Sticking

The process of Example 2 was repeated to prepare a series of electrophoretic media and the corresponding electro-optic devices (5A, 5B, and 5C). The electrophoretic medium of each electro-optic device 5A, 5B, and 5C comprised of yellow dispersion 4A, 4B, and 4C respectively. The image sticking of each electro-optic device was determined by switching the device to a six color block image (White, Black, Red, Yellow, Blue, and Green), inserting and keeping the device in the chamber of a Q-Sun Xenon Arc Tester (supplied by Q-lab) at 50° C. and 35% Relative Humidity, removing the device from the Q-Sun chamber, cooling to room temperature, switching the electro-optic device to its white state, and measuring the color (CIELAB) of white of each color block using a spectrophotometer. The image sticking is determined as the difference in the maximum b* and minimum b*. This is denoted by Δb* in CIELAB. A device with small Δb* (in CIELAB) has less image sticking than a device with a larger Δb*. The evaluation of image sticking can also be performed by visual inspection of the display. A device which shows a stronger yellow tint in comparison to its reference has more image sticking than a device which shows a weaker yellow tint in in comparison to its reference. The results of the image sticking evaluation of electro-optic devices 5A, 5B, and 5C are provided in Table 4.

TABLE 3
Polymer properties of Polymers on Yellow Particle Surface

| | Polymer Content (weight | Weight Average Molecular |
|---|---|---|
| | % by weight of particle) | Weight (Da) |
| Example 4A | 5.1 | 47,000 |
| Example 4B | 3.0 | 55,500 |
| Example 4C | 4.2 | 83,900 |

TABLE 4
Image Sticking Evaluation

| | Δb* of Exposed Surface | Visual Inspection of Exposed |
|---|---|---|
| | versus Unexposed Surface | versus Unexposed Surface |
| Example 5A | 10.8 | Yellow tint |
| Example 5B | 3.6 | Significantly less yellow tint |
| Example 5C | | Significantly less yellow tint |

The evaluation results of Table 4 demonstrate that electro-optic devices that comprise of electrophoretic media with yellow electrophoretic particles the surface of which includes a polymer with weight average molecular weight larger than 55,000 Da shows significant less image sticking.

### Example 6. Preparation of Inventive Magenta Particles

A preparation of Example 1 was repeated but using Pigment Red 122 as the organic pigment core, wherein the polymer of the shell was formed 2-vinylnaphtahlene monomer. Three different experiments were performed 6A, 6B, and 6C varying the polymer content of the magenta particles. Particles from Example 6A comprise 19 weight percent of polymer by weight of the particle (2.5 mmol of monomers were used per g of pigment). Particles from Example 6B comprise 48 weight percent of polymer by weight of the particle (5.0 mmol of monomers were used per g of pigment). Particles from Example 6C comprise 38 weight percent of polymer by weight of the particle (4.0 mmol of monomer were used per g of pigment). The polymer content, the weight average molecular weight (MW), the particle size, and the zeta potential were determined for each example, as shown in Table 5.

TABLE 5
Evaluation of Properties of Magenta Particles

| | | | | Particle size | Zeta |
|---|---|---|---|---|---|
| | Monomer/ | Polymer | | (micro- | potential |
| Example | pigment | content | Mw | meters) | (mV) |
| Ex. 6A | 2.5 mmol/g | 19% | 79,900 | 0.30 | 35 |
| Ex. 6B | 5.0 mmol/g | 48% | 257,500 | 0.31 | 35 |
| Ex. 6C | 4.0 mmol/g | 38% | 185,804 | 0.29 | 31 |

### Example 7. Preparation of Inventive Electro-Optic Device and Stability Evaluation

An electrophoretic medium was prepared using a charged control agent, a hydrocarbon solvent, the positively charged magenta particles form Example 6A, positively charge cyan particles (as described in Example 7 of U.S. Pat. No. 10,509,293), slightly negatively charged yellow particles (Pigment Yellow 155 that is surface treated by a polymer formed from polymerization of methylmethacrylate and monomethacrylate terminated poly(dimethylsiloxane; polymer content 25 weight % by weight of particles), negatively charged white particles (as described in Example 1 of U.S. Pat. No. 8,582,196), and charge control agent CCA-111 (Cationic Charge Control Agent from Example 1—CCA111 of Patent Application US2020/0355978). A microcell electro-optic device was prepared using the electrophoretic medium. The electro-optic device was driven to the white state, the color was measured immediately (t0) and after 24 hours (t24) using a color computer and reported as DE (color difference from t0 to t24 in CIELAB).

### Comparative Example 8. Preparation of Comparative Electro-Optic Device and Stability Evaluation

The procedure of Example 7 was repeated, but, instead of the magenta particles from Example 6A, control magenta particles were used for the comparative electrophoretic medium. Control magenta articles comprise a core and shell, the core comprising the same Pigment Red 122 as used in Example 6A, and a shell that was formed by treating the magenta pigment with vinylbenzylchloride followed by graft polymerization with methyl methacrylate (as described in Example 1 of U.S. Pat. No. 9,697,778). A microcell electro-optic device was prepared using the electrophoretic medium. The electro-optic device was driven to the white state, the color was measured immediately (t0) and after 24 hours (t24) using a color computer and reported as DE (color difference from t0 to t24 in CIELAB).

Stability Evaluation of White State of Examples 7 and 8. The white state of the Inventive device of Example 7 was found to be more stable after 24 hours than the white state of the white state of the device of Example 8, as shown in the data of Table 6. Specifically, the color change from t0 to t24, as expressed in DE, is significantly larger in the white state of the device of Comparative Example 8 than that of the device Inventive Example 6. The white state of the device of Comparative Example 8 shifted over 24 hours to a state having a red tint.

TABLE 6
Color Change of the White State Over Time.

| Electro-Optic Device | Magenta of Electrophoretic Medium | Delta E |
|---|---|---|
| Ex. 7 | Ex. 6A | 3.1 |
| Comparative Ex. 8 | Control | 10.8 |

The results of the evaluation of the inventive and comparative examples described above demonstrated that electro-optic devices comprising inventive electrophoretic media had significantly improved electro-optic performance compared to control electrophoretic media in terms of the image quality and stability.

What is claimed is:

1. An electrophoretic medium comprising a non-polar liquid, a plurality of a first type of particles, and a plurality of second type of particles, each of the plurality of the first type of particles, comprising a core and a shell,
the core comprising a pigment having a surface, the pigment being an organic pigment or an inorganic pigment,
the shell comprising a polymer, the polymer being a homopolymer or a copolymer, the homopolymer being formed by polymerization of a vinylnaphthalene, the copolymer being formed by polymerization of a vinylnaphthalene and a first monomer, the homopolymer or copolymer being in contact with the surface of the pigment.

2. The electrophoretic medium, wherein the polymer of the shell has weight average molecular weight of from 55,000 to 400,000 Da.

3. The electrophoretic medium of claim 1, wherein the vinylnaphthalene is selected from the group consisting of 1-vinylnaphthalene, 2-vinylnaphthalene, a substituted 1-vinylnaphthalene, and a substituted 2-vinylnaphthalene, wherein the substituted 1-vinylnaphthalene and the substituted 2-vinylnaphthalene have one or more substituents on an aromatic carbon of a naphthalene ring in addition to the vinyl substituent.

4. The electrophoretic medium of claim 3, wherein the one or more substituent is selected from the group consisting of halogen, alkoxy group, alkyl group, nitro, carboxyl group, hydroxy group, sulfonic group, sulfonate group, and amino group.

5. The electrophoretic medium of claim 1, wherein the first monomer has a molecular structure, the molecular structure of the first monomer including a functional group selected from the group consisting of a vinyl group, an acrylate group, and a methacrylate group.

6. The electrophoretic medium of claim 1, wherein the first monomer is a macromer, the macromer having a molecular structure that includes a first functional group and a second functional group, the first functional group being a polydimethylsiloxane and the second functional group being a vinyl group, a methacrylate group, or an acrylate group.

7. The electrophoretic medium of claim 1, wherein the first monomer is selected from the group consisting of methyl methacrylate, methyl acrylate, ethyl methacrylate, ethyl acrylate, ethylhexyl methacrylate, ethylhexyl acrylate, lauryl methacrylate, lauryl acrylate, 2,2,2-trifluoroethyl methacrylate, 2,2,2-trifluoroethyl acrylate, styrene, and alpha-methylstyrene.

8. The electrophoretic medium of claim 1, wherein the copolymer is formed by the vinylnaphthalene, the first monomer, and a second monomer, wherein the first monomer is 2,2,2-trifluoroethyl methacrylate and the second monomer has a molecular structure that includes (i) a polydimethylsiloxane and (ii) a vinyl functional group, an acrylate functional group, or a methacrylate functional group.

9. The electrophoretic medium of claim 8, wherein the weight average molecular of the copolymer is from 55,000 to 250,000 Da.

10. The electrophoretic medium of claim 8, wherein the second monomer is monomethacryloxypropyl terminated polydimethylsiloxane.

11. The electrophoretic medium of claim 1, further comprising a plurality of a third type of particles and a plurality of fourth type of particles.

12. The electrophoretic medium of claim 11, wherein each of the plurality of the first type of particles comprises an organic pigment, each of the second and third types of particles comprises an organic pigment, and each of the plurality of the fourth type of particles comprises an inorganic pigment.

13. The electrophoretic medium of claim 11, wherein the first, second, and third types of particles have a first charge polarity, the fourth type of particles have a second charge polarity, and the first charge polarity is opposite to the second charge polarity.

14. The electrophoretic medium of claim 11, wherein the first and third types of particles have a first charge polarity, wherein the second and fourth types of particles have a second charge polarity, and the first charge polarity is opposite to the second charge polarity.

15. The electrophoretic medium of claim 11, wherein the color of the first, second, and third types of particles is independently selected from the group selected from cyan, magenta, yellow, blue, green, and red, and wherein the color of the fourth type of particles is white.

16. The electrophoretic medium of claim 11, wherein the first, second and third types of particles are independently selected from the group consisting of an azo pigment, a phthalocyanine pigment, a quinacridone pigment, a perylene pigment, a diketopyrrolopyrrole pigment, a benzimidazolone pigment, an isoindoline pigment, an anthranone pigment, an indanthrone pigment, a rhodamine pigment, a benzinamine pigment, a carbon black pigments, and mixtures therein.

17. An electro-optic device comprising a first light-transmissive electrode layer, an electro-optic material layer comprising the electrophoretic medium of claim 1, and a second electrode layer, wherein the electro-optic material layer comprises a plurality of microcapsules or a plurality of microcells, each microcapsule of the plurality of microcapsules or each microcell of the plurality of microcells comprising the electrophoretic medium.

18. A method of manufacture of an electrophoretic medium, the electrophoretic medium comprising a non-polar liquid and a plurality of a first type of particles, the first type of particles having a core and a shell, the method of manufacture comprising the steps:
providing a first dispersion comprising an organic pigment in a first organic solvent;
adding a vinylnaphthalene, a first monomer, and a free radical initiator into the first dispersion to form the first type of particles;
washing the first type of particles with a second organic solvent; and
dispersing the washed particles in a non-polar liquid.

19. The method of manufacture of an electrophoretic medium of claim 18, wherein the first dispersion further comprises a charge control agent.

20. The method of manufacture of an electrophoretic medium of claim 18 further comprising a step of adding a charge control agent into the dispersion of the washed particles in the non-polar liquid.
